(19) United States
(12) Patent Application Publication
(10) Pub. No.: US 2016/0370056 A1
(43) Pub. Date: Dec. 22, 2016

(54) REFRIGERATOR AND MANUFACTURING METHOD THEREOF

(71) Applicant: Dongbu Daewoo Electronics Corporation, Seoul (KR)

(72) Inventor: Min Jae KIM, Seoul (KR)

(21) Appl. No.: 14/838,320

(22) Filed: Aug. 27, 2015

(30) Foreign Application Priority Data
Jun. 18, 2015 (KR) 10-2015-0086615

(51) Int. Cl. F25C 1/04; F25C 1/22; B23P 15/26

(52) U.S. Cl. CPC F25C 1/04; B23P 15/26; F25C 1/225; F25C 2400/14; F25C 2500/08

(57) ABSTRACT

According to one embodiment of the present disclosure, a refrigerator includes: a main body; doors combined with the main body so as to be rotatable; a dispenser provided within the door and configured to provide drinking water or ice; an ice maker to produce ice; and a water supply pipe system extending from the main body, connected to the ice maker or the dispenser, providing a path of water supplied from the outside to the ice maker or the dispenser, and including a hydrophobic material layer formed on the inner surface of the water supply pipe.

### RELATED APPLICATIONS

This application claims priority to Korean Patent Application No. 10-2015-0086615, filed on Jun. 18, 2015, the disclosure of which is herein incorporated by reference in its entirety for all purposes.

### FIELD OF THE INVENTION

The embodiments of the present invention relate to a refrigerator and a manufacturing method thereof, and, more particularly, to a more efficient refrigerator.

### BACKGROUND OF THE INVENTION

A refrigerator is an apparatus to store food at a low temperature; it may store food in a frozen state or at a low, but above-zero, temperature, according to the kinds of food to be stored.

The inside of the refrigerator is cooled by continuously supplied cool air; this cool air is continuously generated by heat exchange of a refrigerant through a refrigeration cycle consisting of compression, condensation, expansion and evaporation. The cool air supplied to the inside of the refrigerator is uniformly transmitted to the inside of the refrigerator by convection.

In general, a refrigerator main body has a rectangular parallelepiped shape, the front surface of which can be opened, and a refrigerating compartment and a freezing compartment may be provided within the refrigerator main body. Further, a refrigerating compartment door and a freezing compartment door selectively open and close the refrigerating compartment and the freezing compartment and may be located on the front surface of the main body. A plurality of drawers, shelves and holding boxes to store various kinds of food in optimum states may be located within a storage space within the refrigerator.

A dispenser to provide ice or water for user convenience may also be installed on the refrigerator. Such a dispenser may receive water supplied from the outside through a water supply pipe (or a water supply pipe system), provide drinking water, and provide ice produced by an ice maker.

Often, such a dispenser or an ice maker is located within the door of a freezing or refrigerating compartment. Here, the water supply pipe extends from the main body of the refrigerator and is connected to the dispenser or ice maker through a hinge part. The water supply pipe passes through the freezing or refrigerating compartment on a connection path.

Therefore, water supplied to the dispenser or the ice maker through the water supply pipe may be frozen by cool air from the freezing compartment or the refrigerating compartment. Further, if water remains in the water supply pipe, such freezing may occur more frequently. For example, if a switching valve is connected to one end of the water supply pipe and blocks the water supply, water may remain in the water supply pipe and freeze.

Conventionally, in order to prevent such freezing, a separate heater unit may be installed in the water supply pipe. However, the inclusion of a heater unit has some drawbacks. For example, additional electrical power is required to operate the heater unit. Costs are associated with the inclusion of a heater unit, and the cooling performance of the freezing compartment or the refrigerating compartment may be lowered due to heat generated by the heater unit.

### SUMMARY OF THE INVENTION

Embodiments of the present invention have been conceived with the aforementioned problems in mind. It is an object of the embodiments of the present invention to provide a refrigerator which prevents freezing of the water supply pipe without the need of a separate heater unit, and to provide a manufacturing method thereof.

According to one embodiment of the present disclosure, a refrigerator includes: a main body; doors combined with the main body so as to be rotatable; a dispenser provided within the door and configured to provide drinking water or ice; an ice maker to produce ice; and a water supply pipe system extending from the main body, connected to the ice maker or the dispenser, providing a path of water supplied from the outside to the ice maker or the dispenser, and including a hydrophobic material layer on the inner surface of the water supply pipe.

According to one embodiment, an opening is located on the water supply pipe system in the length direction so that the cross section of the water supply pipe system has a substantially semi-circular shape.

According to one embodiment still, the hydrophobic material layer is Teflon; but other materials may be suitable.

According to another embodiment of the present disclosure, a manufacturing method of a refrigerator includes: preparing a main body; mounting rotatable doors on the main body; inserting a dispenser in the door to provide drinking water or ice; including an ice maker to produce the ice; including a water supply pipe system extending from the main body, connected to the ice maker or the dispenser and providing a path of water supplied from the outside to the ice maker or the dispenser; and including a hydrophobic material layer on the inner surface of the water supply pipe.

Further, the method includes forming an opening on the water supply pipe in the length direction so that the cross section of the water supply pipe has a substantially semi-circular shape.

Further, the hydrophobic material layer may include Teflon.

### BRIEF DESCRIPTION OF THE DRAWINGS

The above and other objects, features and other advantages of the embodiments will be more clearly understood from the following detailed description taken in conjunction with the accompanying drawings, in which:

FIG. 1 is a perspective view showing a refrigerator in accordance with one embodiment of the present invention;

FIGS. 2A and 2B show cross sections of exemplary water supply pipes provided in the refrigerator in accordance with the embodiment of the present invention; and

FIG. 3 is a sequential illustration of an exemplary manufacturing method of a refrigerator in accordance with one embodiment of the present invention.

### DETAILED DESCRIPTION

In these specifications, a ‘refrigerator’ refers to a home appliance to provide cool air to food and other objects, e.g., a refrigerator, or freezer or a refrigerating/freezing apparatus having a combination thereof.

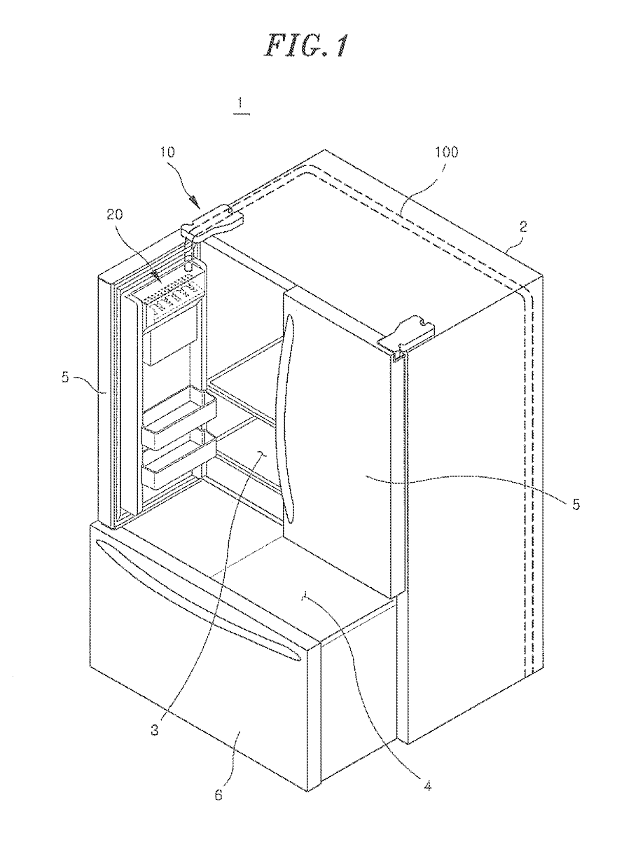

FIG. 1 is a perspective view showing an exemplary refrigerator in accordance with one embodiment of the present invention. A refrigerator 1 in accordance with one embodiment of the present invention may include a main body 2, a barrier (not shown) within the main body 2 dividing a storage space to store food and other objects into a refrigerating compartment 3 located in the upper space and a freezing compartment 4 located in the lower space, a pair of refrigerating compartment doors 5 located at both edges of the front surface of the main body 2 and rotated to selectively close the refrigerating compartment 3. It may also include a freezing compartment door 6 to close the front opening of the freezing compartment 4, a cooling unit (not shown) including a compressor, a condenser, an expansion valve, and an evaporator to perform a refrigeration cycle and generate cool air through heat exchange between a refrigerant and air, an ice maker (not shown) mounted in the refrigerating compartment door 5 for making ice using cool air supplied from the cooling unit, a dispenser 20 mounted in the refrigerating compartment door 5 for providing drinking water or ice produced by the ice maker, and a water supply pipe system 100 for supplying water to the ice maker or the dispenser 20.

Such a configuration is merely exemplary and the refrigerator 1 may exclude at least one of these elements or include other elements in addition to these elements according to embodiments. Further, the relative positions of the refrigerating compartment 3 and the freezing compartment 4 can differ.

The ice maker is connected to the water supply pipe system 100; it receives water from the water supply pipe and makes ice. For this purpose, the ice maker may include an ice tray (not shown) to provide a space that receives water supplied from the water supply pipe system 100. It may also include a cool air guide (not shown) to guide the flow of cool air supplied from the cooling unit so as to move along the bottom surface of the ice tray. It may further include a rotating unit (not shown) to rotate the ice tray so as to eject the produced ice from the ice tray.

The dispenser 20 may provide the ice produced by the ice maker; this ice may be discharged through an ice dispenser port located on the outer surface of the refrigerating compartment door 5.

Further, the dispenser 20 is connected to the water supply pipe system 100 and may thus receive water from the water supply pipe system 100 and provide such water as drinking water. For this purpose, the dispenser 20 may be provided with a water providing outlet (not shown in the drawings) facing away from the refrigerating compartment door 5.

The ice maker and the dispenser 20 may be located in the upper area of the inside of the refrigerating compartment door 5 but such a position is only exemplary. The ice maker and the dispenser 20 may be located elsewhere on the inside of the refrigerating compartment door 5 or mounted within the freezing compartment door 6.

The water supply pipe system 100 may provide water supplied from the outside to the ice maker or the dispenser 20. More specifically, one end of the water supply pipe system 100 may be connected to a water supply source, such as a tap. Further, as shown in FIG. 1, the water supply pipe system 100 may extend from the main body 2, pass through a hinge part 10, be received in the refrigerating compartment door 5, and then be connected to the ice maker or the dispenser 20 located in the refrigerating compartment door 5.

In addition, the water supply pipe system 100 may include a switching valve (not shown) to control and stop the supply of water from the source. The water supply pipe system 100 may be mounted in the main body 20 and selectively provide water from the supply pipe to the ice maker or the dispenser 20.

Here, the other end of the water supply pipe system 100 connected to the ice maker or the dispenser 20 may be directly affected by cool air from the cooling unit or the refrigerating compartment 3. Particularly, if water remains in the water supply pipe system 100 when the switching valve blocks the water supply, it may be frozen by such cool air.

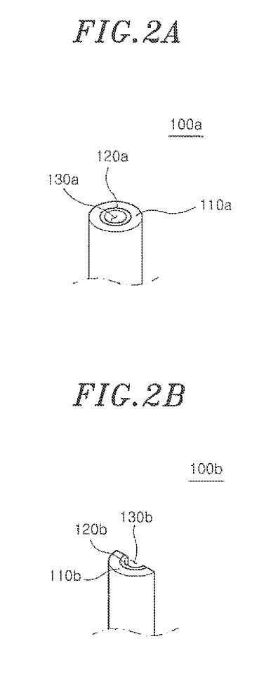

It is appreciated that in one embodiment of the present invention, the water supply pipe system 100 may comprise a layer of hydrophobic material to prevent water from remaining in the water supply pipe. Such a hydrophobic material layer is described in more detail in FIGS. 2A and 2B.

FIG. 2A shows the cross section of a water supply pipe provided in the refrigerator in accordance with one embodiment of the present invention.

With reference to FIG. 2A, a water supply pipe system 100a may include a conduit part 130a located at the innermost region and providing a void space in which water flows, a hydrophobic material layer 120a, in contact with water, forming the conduit part 130a, and a flow path part 110a surrounding the hydrophobic material layer 120a and forming the external casing of the water supply pipe system 100a.

The conduit part 130a is a space in which water supplied from the outside flows. It may, for example, have a circular or polygonal cross section.

The flow path part 110a forms the outermost portion of the water supply pipe system 100a. It may, for example, be a tube formed of plastic, such as polyethylene (PE), or a pipe formed of aluminum.

The hydrophobic material layer 120a is a layer located on the inner surface of the flow path part 110a, e.g., on the inner surface of the water supply pipe system 100a. It may be in contact with water. Further, the hydrophobic material layer 120a may be formed, for example, by coating.

Here, a hydrophobic material can be a material having relatively low adhesiveness with water. Such a hydrophobic material may be, for example, Teflon. Teflon has hydrophobicity and non-adhesiveness and has a low coefficient of friction relative to other materials. Further, Teflon is chemically resistant and does not corrode even if it is in contact with water.

Therefore, in accordance with one embodiment of the present invention, if the switching valve stops the water supply, the layer of hydrophobic material 120a will cause the water inside the water supply pipe to flow out, thereby preventing freezing thereof.

The water supply pipe system 100b shown in FIG. 2B is the same as the water supply pipe system 100a shown in FIG. 2A except that it has an opening formed by cutting the water supply pipe system 100a shown in FIG. 2A in the length direction. That is, as shown in FIG. 2B, the cross section of the water supply pipe system 100b has a semi-circular shape.

The water supply pipe system 100b shown in FIG. 2B may allow water to flow to the outside in the same manner as the water supply pipe system 100a shown in FIG. 2A does, but it also eliminates pressure buildup, thus allowing water to remain in the water supply pipe system 100b and eventually more effectively flow to the outside.

In accordance with an embodiment of the present invention, cool air generated by the cooling unit (not shown) is provided to the refrigerating compartment 3 or the freezing compartment 4.

Further, the drinking water or ice dispenser 20 is located within the refrigerating compartment door 5 and the ice maker is located within the refrigerating compartment door 5. The water supply pipe system 100 extends from the main body 2, passes through the hinge part 10, is connected to the ice maker or the dispenser 20, and provides water.

Here, water passing through the water supply 100 may be frozen by cool air provided from the refrigerating compartment 3 or cool air used by the ice maker to produce ice. Particularly, if the switching valve (not shown) provided on the water supply pipe system 100 stops the water supply, water may remain in the water supply pipe system 100 and freeze.

In order to solve this problem, the hydrophobic material layer 120a may be formed on the inner surface of the water supply pipe system 100, in contact with water. The hydrophobic material layer 120a may cause water to flow to the outside without remaining in the water supply pipe system 100a.

Therefore, in accordance with the embodiment of the present invention, water does not remain in the water supply pipe system 100 and, thus, the freezing of the water supply pipe system 100 may be prevented without the need to install a separate heater unit.

Further, as shown in FIG. 2B, the water supply pipe system 100b may have an opening formed by cutting the water supply pipe system 100a in the length direction. In this case, the cross section of the water supply pipe system 100b may have a semi-circular shape.

Therefore, in accordance with an embodiment of the present invention, the water supply pipe system 100b shown in FIG. 2B may allow water to flow to the outside in the same manner as the water supply pipe system 100a shown in FIG. 2A does, but it also eliminates the pressure buildup, thus allowing water to remain in the water supply pipe system 100b and eventually more effectively flow to the outside.

Hereinafter, a manufacturing method of a refrigerator in accordance with one embodiment of the present invention is described.

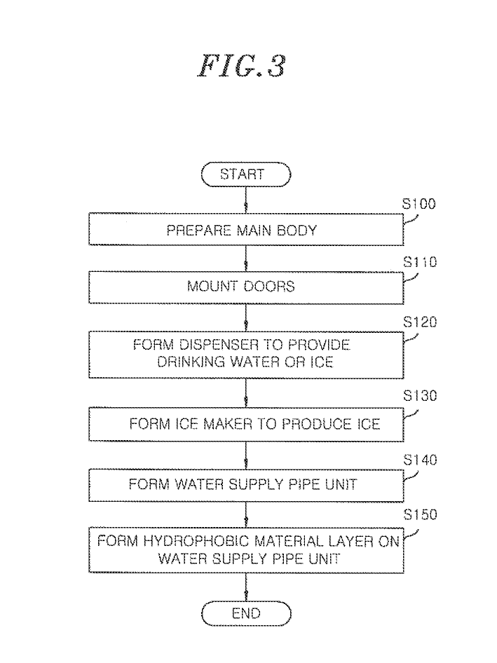

FIG. 3 is a sequential view showing an exemplary manufacturing method for a refrigerator in accordance with an embodiment of the present invention.

With reference to FIG. 3, a manufacturing method of a refrigerator 1 in accordance with the above-described embodiment of the present invention may include preparing a main body 2 (Operation S100), mounting rotatable doors on the main body (Operation S110), inserting a dispenser 20 within the door to provide drinking water or ice (Operation 5120) and including an ice maker to produce ice (Operation S130). It may also comprise including a water supply pipe system 100 extending from the main body 2, connected to the ice maker or the dispenser 20 and providing a path of water supplied from the outside to the ice maker or the dispenser 20 (Operation S140), and forming a hydrophobic material 120a on the inner surface layer of the water supply pipe system 100 (Operation S150). However, the manufacturing method is merely exemplary and may thus exclude at least one of these operations or include other operations in addition to these operations.

The manufacturing method may further include forming an opening on the water supply pipe system 100 in the length direction so that the cross section of the water supply pipe system 100 has a substantially semi-circular shape, according to various embodiments.

In the formation of the hydrophobic material layer 120a (Operation S140), the hydrophobic material layer 120a may be formed, for example, by coating the inner surface of a flow path part 110a.

Further, the hydrophobic material may be a material having relatively low adhesiveness with water, for example, Teflon. Of course, any suitable material can be used.

As apparent from the above description, a refrigerator and a manufacturing method thereof in accordance with embodiments of the present invention advantageously prevent water from remaining in a water supply pipe and may thus prevent freezing in the water supply pipe, without the need to install a separate heater unit, thereby reducing power, saving the costs associated with the inclusion and operation of the heater unit, and preventing the lowering of the performance due to heat emitted from the heater unit.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A refrigerator comprising:
a main body;
doors disposed on the main body to be rotatable;
a dispenser located within a door and configured to provide drinking water or ice;
an ice maker to produce ice; and
a water supply pipe extending from the main body and coupled to the ice maker or the dispenser and providing a path of water supplied from outside the refrigerator to the ice maker or the dispenser, and wherein said pipe further comprises a hydrophobic material layer formed on the inner surface of the pipe.

2. The refrigerator according to claim 1, wherein an opening is formed on the pipe in the length direction wherein the cross section of the pipe has a substantially semi-circular shape.

3. The refrigerator according to claim 1, wherein the hydrophobic material layer comprises Teflon material.

4. A manufacturing method of a refrigerator, the method comprising:
preparing a main body;
mounting rotatable doors on the main body;
inserting a dispenser in the door to provide drinking water or ice;
installing an ice maker to produce the ice;
installing a water supply pipe extending from the main body, connected to the ice maker or the dispenser and providing a path of water supplied from the outside to the ice maker or the dispenser; and
disposing a hydrophobic material layer on the inner surface of the water supply pipe.

5. The manufacturing method according to claim 4, further comprising forming an opening on the water supply pipe in the length direction wherein the cross section of the water supply pipe has a substantially semi-circular shape.

6. The manufacturing method according to claim 4, wherein the hydrophobic material layer is Teflon.

7. A refrigerator comprising:
a main body means;
door means disposed on the main body means and configured to be rotatable;
a dispenser means located within one of the door means and configured to provide drinking water or ice;
an ice maker means to produce ice; and
a water supply pipe extending from the main body means and coupled to the ice maker means or the dispenser means and providing a path of water supplied from outside the refrigerator to the ice maker means or the dispenser means, and wherein said pipe further comprises a hydrophobic material layer formed on the inner surface of the pipe.

8. The refrigerator according to claim 7, wherein an opening is formed on the pipe in the length direction wherein the cross section of the pipe has a substantially semi-circular shape.

9. The refrigerator according to claim 7, wherein the hydrophobic material layer comprises Teflon material.
